(19) United States
(12) Patent Application Publication
(10) Pub. No.: US 2017/0295200 A1
(43) Pub. Date: Oct. 12, 2017

(54) Distributed Denial Of Service Attack Protection

(71) Applicant: Taric Mirza, Atlanta, GA (US)

(72) Inventor: Taric Mirza, Atlanta, GA (US)

(21) Appl. No.: 15/484,789

(22) Filed: Apr. 11, 2017

Related U.S. Application Data
(60) Provisional application No. 62/320,884, filed on Apr. 11, 2016.

(51) Int. Cl. H04L 29/06

(52) U.S. Cl. CPC H04L 63/1458; H04L 2463/141

(57) ABSTRACT

Disclosed are systems and methods for distributed denial of service (DDoS) protection. One or more nodes in a plurality of routes between a first node and a second node are identified. The one or more nodes can be identified at a predefined interval, or in response to one or more operational metrics exceeding a threshold. Network addresses of the identified one or more nodes are modified.

### CROSS REFERENCE TO RELATED PATENT APPLICATION

This application claims priority to U.S. Provisional Application No. 62/320,884, filed Apr. 11, 2016, herein incorporated by reference in its entirety.

### BACKGROUND

Networked computing systems may be vulnerable to distributed denial of service (DDoS) attacks. Such attacks may be targeted to hinder the operability of communications endpoints, or intermediary points in a communications path.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views:

FIG. 1 is a drawing of a networked environment according to various embodiments of the present disclosure;

FIG. 2 is a flowchart of an example method;

FIG. 3 is a flowchart of an example method; and

FIG. 4 is a block diagram of an example computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

In various instances, this detailed description may refer to content items (which may also be referred to as “content,” “content data,” “content information,” “content asset,” “multimedia asset data file,” or simply “data” or “information”). In some instances, content items can comprise any information or data that may be licensed to one or more individuals (or other entities, such as business or group). In various embodiments, content may include electronic representations of video, audio, text and/or graphics, which may include but is not limited to electronic representations of videos, movies, or other multimedia, which may include but is not limited to data files adhering to MPEG2, MPEG, MPEG4 UHD, HDR, 4 k, Adobe® Flash® Video (.FLV) format or some other video file format whether such format is presently known or developed in the future. In various embodiments, the content items described herein may include electronic representations of music, spoken words, or other audio, which may include but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. In some embodiments, content items may include any combination of the above-described examples.

In various instances, this detailed disclosure may refer to consuming content or to the consumption of content, which may also be referred to as “accessing” content, “providing” content, “viewing” content, “listening” to content, “rendering” content, or “playing” content, among other things. In some cases, the particular term utilized may be dependent on the context in which it is used. For example, consuming video may also be referred to as viewing or playing the video. In another example, consuming audio may also be referred to as listening to or playing the audio.

Note that in various instances this detailed disclosure may refer to a given entity performing some action. It should be understood that this language may in some cases mean that a system (e.g., a computer) owned and/or controlled by the given entity is actually performing the action.

The present disclosure relates to systems and methods for distributed denial of service (DDoS) attack prevention. Distributed denial of service (DDoS) attacks are used to hinder the operability of a computing system by overloading the system with requests or data. Typically, multiple compromised systems are used to simultaneously send large numbers of requests to a computing system. Such attacks can overload the available bandwidth or computational resources of the targeted computing system as the targeted computing system attempts to process the volume of requests. Such attacks can also include providing large volumes of requests or packets, causing the targeted computing system to fail to process or respond to legitimate network traffic.

Existing methods to prevent DDoS attacks are most effective in Transmission Control Protocol (TCP) systems. However, these solutions may not be effective in the context of a parallel multipath network architectures, such as those set forth in Such operations are disclosed in U.S. patent application Ser. No. 14/948,561, “PARALLEL MULTIPATH ROUTING ARCHITECTURE,” filed Nov. 23, 2015, which is hereby incorporated by reference in its entirety. A parallel multipath network architecture implements an overlay network on existing Internet Protocol network frameworks. The overlay network includes edge nodes communicatively coupled to communication endpoints. Relay nodes are communicatively coupled to the edge nodes and other relay nodes, creating multiple parallel network paths terminating at a respective edge node. In some implementations, the relay nodes and edge nodes are configured to communicate with each other using User Datagram Protocol (UDP) packets. Thus, the open UDP sockets create vulnerabilities to DDoS attacks that are not remedied using existing TCP-based solutions.

A controller application queries the relay nodes and edge nodes of the overlay network for relay data, indicating an operational status of the respective nodes. The controller application uses the relay data to identify paths in the overlay network between the edge nodes. The relay nodes and edge nodes are then notified by the controller application of which routes and relay nodes should be used to communicate traffic between the edge nodes. In order to prevent DDoS attacks targeting particular network addresses of relay nodes or edge nodes, the relay nodes and edge nodes may be configured to refresh or renew their network addresses periodically. This may be performed, for example, in response to a request from the controller application, at a predefined interval, or according to other criteria. The controller application, knowing of the new network address for a respective node, provides updated routing information to the relay nodes or edge nodes affected by the change in network address. This may include, for example, other nodes sharing a route with the node having the updated network address. Thus, communications across the parallel multipath network architecture can continue according to the updated network addresses.

In the following discussion, a general description of the system and its components is provided, followed by a discussion of the operation of the same.

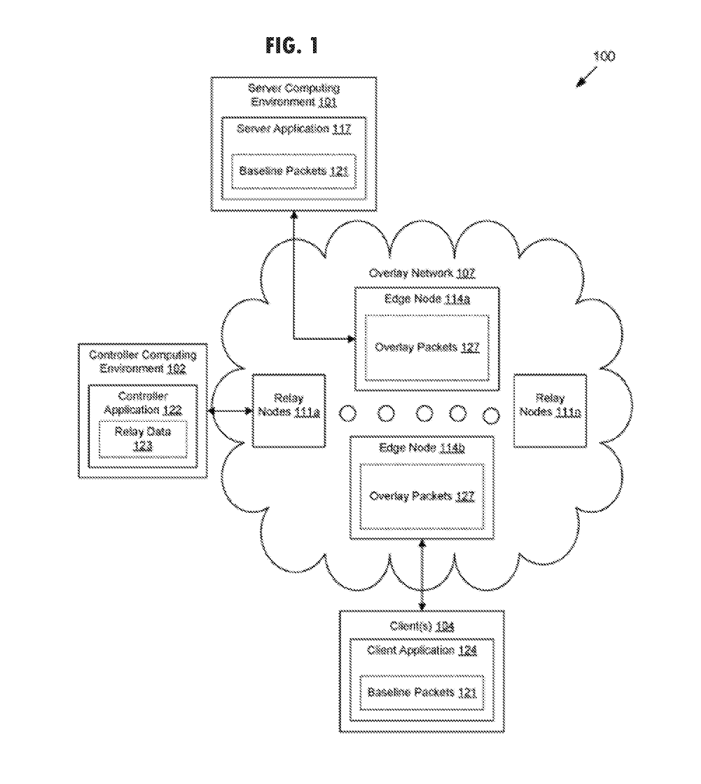

With reference to FIG. 1, shown is a networked environment 100 according to various embodiments. The networked environment 100 includes a server computing environment 101, a controller computing environment 102 and a client 104, which are in data communication with each other via an overlay network 107. The overlay network 107 includes, for example, the Internet, wired networks, wireless networks, or other suitable networks, etc., or any combination of two or more such networks. For example, such networks may comprise satellite networks, cable networks, Ethernet networks, and other types of networks.

To this end, the overlay network 107 comprises one or more relay nodes 111a-n and edge nodes 114a/b, which can include a subset of network components or nodes of a network upon which the overlay network 107 lies. Relay nodes 111a-n are communicatively coupled to other relay nodes 111a-n and/or to edge nodes 114a/b. Edge nodes 114a/b are communicatively coupled to relay nodes 111a-n or network source or destination endpoints, such as the server computing environment 101 and client 104. Relay nodes 111a-n may correspond to data centers, network locations, routers, communications nexus, or other network components communicatively coupled to other relay nodes 111a-n and edge nodes 114a/b via an overlay network approach. For example, relay nodes 111a-n may be communicatively coupled to other relay nodes 111a-n or edge nodes 114a/b using tunneling, including Transmission Control Protocol (TCP) over Internet Protocol (IP)/Universal Datagram Protocol (UDP) tunneling, UDP over IP/UDP tunneling, Secure Shell (SSH) tunneling, Virtual Private Networks (VPNs), or other approaches as can be appreciated.

The edge nodes 114a/b may include dedicated networking devices, such as routers, switches, or other devices configured to perform the operations of edge nodes 114a/b as will be described below. The edge nodes 114a/b may also include software, applications, services, or other functionality configured to perform the operations of edge nodes 114a/b and executed in one or more computing devices. Although, in this example embodiment, the edge nodes 114a/b are shown as distinct from the server computing environment 101 and client 104, it is understood that the edge nodes 114a/b may also include components or functionality executed within the server computing environment 101 or client 104. As a non-limiting example, a client 104 may be configured to execute an application facilitating the operations of an edge node 114b as can be appreciated.

The server computing environment 101 may comprise, for example, a server computer or any other system providing computing capability. Alternatively, the server computing environment 101 may employ a plurality of computing devices that may be arranged, for example, in one or more server banks or computer banks or other arrangements. Such computing devices may be located in a single installation or may be distributed among many different geographical locations. For example, the server computing environment 101 may include a plurality of computing devices that together may comprise a hosted computing resource, a grid computing resource and/or any other distributed computing arrangement. In some cases, the server computing environment 101 may correspond to an elastic computing resource where the allotted capacity of processing, network, storage, or other computing-related resources may vary overtime.

Various applications and/or other functionality may be executed in the server computing environment 101 according to various embodiments. The components executed on the server computing environment 101, for example, include a server application 117, and other applications, services, processes, systems, engines, or functionality not discussed in detail herein. The server application 117 is executed to communicate baseline packets 121 of data to and receive baseline packets 121 of data from a client 104 via the overlay network 107.

The controller computing environment 102 may comprise, for example, a server computer or any other system providing computing capability. Alternatively, the controller computing environment 102 may employ a plurality of computing devices that may be arranged, for example, in one or more server banks or computer banks or other arrangements. Such computing devices may be located in a single installation or may be distributed among many different geographical locations. For example, the controller computing environment 102 may include a plurality of computing devices that together may comprise a hosted computing resource, a grid computing resource and/or any other distributed computing arrangement. In some cases, the controller computing environment 102 may correspond to an elastic computing resource where the allotted capacity of processing, network, storage, or other computing-related resources may vary over time.

Various applications and/or other functionality may be executed in the controller computing environment 102 according to various embodiments. The components executed on the controller computing environment 102, for example, include a controller application 122, and other applications, services, processes, systems, engines, or functionality not discussed in detail herein. The controller application 122 is executed to query relay nodes 111a-n for relay data 123 indicating an operational status of a respective relay node 111a-n. The relay data 123 may indicate, for example, a latency between the respective relay node 111a-n and another relay node 111a-n, edge node 114a/b, or other component of the overlay network 107. The relay data 123 may also indicate a current pending workload or capacity of the respective relay node 111a-n, or other data. Using the relay data 123, the controller application 122 may then determine an optimal route or portion of a route between edge nodes 114a/b.

The controller application 122 may send update requests to relay node 111a-n or edge node 114a/b, indicating that the respective node should refresh or modify a network address such as an Internet Protocol (IP) address. Additionally, the controller application 122 may determine an operability of a relay node 111a-n or edge node 114a/b, indicating whether or not the node is being targeted by a DDoS attack. To this end, the controller application 122 may send requests to relay nodes 111a-n or edge nodes 114a/b to take remedial actions. The controller application 122 may also update paths in the overlay network 107 to circumvent or exclude an attached node, as will be described in more detail below.

The client 104 is representative of a plurality of client devices that may be coupled to the overlay network 107. The client 104 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client 104 may include a display. The display may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client 104 may be configured to execute various applications such as a client application 124 and/or other applications. The client application 124 may be executed in a client 104, for example, to access network content served up by the server computing environment 101 and/or other servers, thereby rendering a user interface on the display. To this end, the client application 124 may comprise, for example, a browser, a dedicated application, etc., and the user interface may comprise a network page, an application screen, etc. The client 104 may be configured to execute applications beyond the client application 124 such as, for example, email applications, social networking applications, word processors, spreadsheets, and/or other applications. The client application 124 may be configured, for example, to generate baseline packets 121 for communication to the server computing environment 101. The client application 124 may also be configured to access data of baseline packets 121 received from the server computing environment 101 to perform its functionality.

Next, a general description of the operation of the various components of the networked environment 100 is provided. To begin, a client 104 communicates a request to the controller application 122 to establish a route between a corresponding edge node 114b and an edge node 114a of a server computing environment 101. In response to the request, the controller application 122 queries one or more relay nodes 111a-n for their relay data 123. Using the relay data 123, the controller application 122 uses a path finding or graph search algorithm to generate a plurality of routes between the edge nodes 114a/b according to the relay data 123. In some embodiments, the routes may be generated to minimize a latency between the edge node 114a and 114b. In other embodiments, the routes may be generated to avoid or preferably avoid the use of relay nodes 111a-n having a pending workload meeting or exceeding a threshold, or a capacity meeting or falling below another threshold.

After generating the routes, in some embodiments, the controller application 122 communicates an indication of the routes to the edge node 114b, such that overlay packets 127 may be encoded with an indication of a respective route. This allows the overlay packets 127 to be communicated to relay nodes 111a-n with an indication of a communications path through the overlay network 107.

In other embodiments, the controller application 122 communicates, to the edge node 114b, an indication of one or more first relay nodes 111a-n in the path. In such an embodiment, the controller application 122 may also communicate to relay nodes 111a-n included in the routes an indication of a respective subsequent relay node 111a-n to which overlay packets 127 should be forwarded. Thus, the edge node 114b and relay nodes 111a-n are only instructed a next node to which overlay packets 127 should be forwarded. In some embodiments, the forwarding instructions to the relay nodes 111a-n may be specific to overlay packets 127 to or from a particular client 104, client application 124, or destination edge node 114a. Thus, relay nodes 111a-n would select a next relay node 111a-n according to the received instructions and a source or destination of the overlay packets 127.

In further embodiments, the controller application 122 may repeatedly query the relay nodes 111a-n for relay data 123 at a predefined interval, in response to a request, or according to other criteria. For example, an edge node 114a/b, relay node 111a-n, or other component of the networked environment 100b may detect a network status such as a network component outage, an operational metric such as a latency, workload, capacity, pending processes, or operational metric meeting or exceeding a threshold, or another event. The detecting component may then communicate a request to the controller application 122 to requery the relay nodes 111a-n for relay data 123. In such embodiments, the controller application 123.

The edge nodes 114a/b may then communicate with each other by splitting baseline packets 121 into overlay packets 127, which are then duplicated and communicated in parallel through the relay nodes 111a-n according to the routes identified by the controller application 122. Such operations are disclosed in U.S. patent application Ser. No. 14/948,561, “PARALLEL MULTIPATH ROUTING ARCHITECTURE,” filed Nov. 23, 2015. In some embodiments, the overlay packets 127 may be communicated through the relay nodes 111a-n as User Datagram Protocol (UDP) Packets, although the overlay packets 127 may be communicated by another approach.

During the operations of the relay nodes 111a-n and edge nodes 114a/b, the controller application 122 may communicate with the respective nodes in order to prevent their being victim of a DDoS attack. In some embodiments, the controller application 122 may perform the following operations by establishing a Transmission Control Protocol (TCP) session with the respective nodes, with the disclosed notifications or communications being communicated as TCP packets in the TCP session.

For example, the controller application 122 may communicate a notification to a relay node 111a-n or edge node 114a/b indicating that the respective node should change their network address, such as an Internet Protocol (IP) address. In some embodiments, the relay node 111a-n or edge node 114a/b may be configured to renew or refresh their network address in response to the notification. This may include querying a Dynamic Host Configuration Protocol (DHCP) server for a new network address. In other embodiments, this may include iterating or otherwise modifying a current network address to generate a new network address. In further embodiments, the controller application 122 may facilitate or simulate DHCP or other network address allocation functionality. In such an embodiment, the notification communicated to the relay node 111a-n or edge node 114a/b may also indicate a new network address for the respective node. In some embodiments, when modifying or refreshing a network address for a relay node 111a-n or edge node 114a/b, the new network address may be taken from a pool of network addresses with or without replacement.

The controller application 122 may notify a relay nodes 111a-n or edge nodes 114a/b to modify their network address according to various criteria. In some embodiments, the controller application 122 may be configured to notify the relay nodes 111a-n or edge nodes 114a/b of a network address change at a predefined interval. The notification may include one or more new routes, or an indication of a change or delta in network addresses. In some embodiments, this may include notifying a subset of relay nodes 111a-n or edge nodes 114a/b to update their network addresses at a given interval, thereby staggering which of the relay nodes 111a-n or edge nodes 114a/b are updating their network addresses. This allows for some of the respective nodes to update their network addresses, but preserving previously identified routes through non-updated nodes. Thus, traffic may still be communicated through unaffected routes while the changes in network addresses are propagated to nodes in affected routes, as will be described below.

In other embodiments, this may be performed in response to relay data 123 for a respective node indicating a latency, workload, or other operational metric meeting or exceeding a predefined threshold. In further embodiments, this may be performed in response to a failure to receive relay data 123 or a heartbeat message at a predefined interval, indicating that the respective node may be under attack.

After a change in network address by a relay node 111a-n or edge node 114a/b, the controller application 122 may update previously identified routes to reflect the change. In some embodiments, this may include communicating updated routing information to relay nodes 111a-n or edge nodes 114a/b configured to route overlay packets 127 to the relay node 111a-n or edge node 114a/b having the new network address. Thus, the parallel multipath communication of overlay packets 127 can be maintained as network addresses of relay nodes 111a-n or edge nodes 114a/b are updated.

By changing the network addresses of relay nodes 111a-n or edge nodes 114a/b, DDoS attacks targeting a particular network address would cease to be a threat. By virtue of the overlay packets 127 being sent across multiple routes in parallel, the communications sessions between edge nodes 114a/b would receive minimal-to-no degradation in performance due to an attack directed to a subset of relay nodes 111a-n. A relay node 111a-n or edge node 114a/b targeted by the DDoS attack can be restored to full functionality once a new network address is assigned, as the DDoS attack will be directed to an obsolete network address. Furthermore, as the identification of routes in the overlay network 107 is managed by the controller application 122, new routes can be identified that exclude the attacked relay nodes 111a-n, thereby preserving the operational uptime of the overlay network 107.

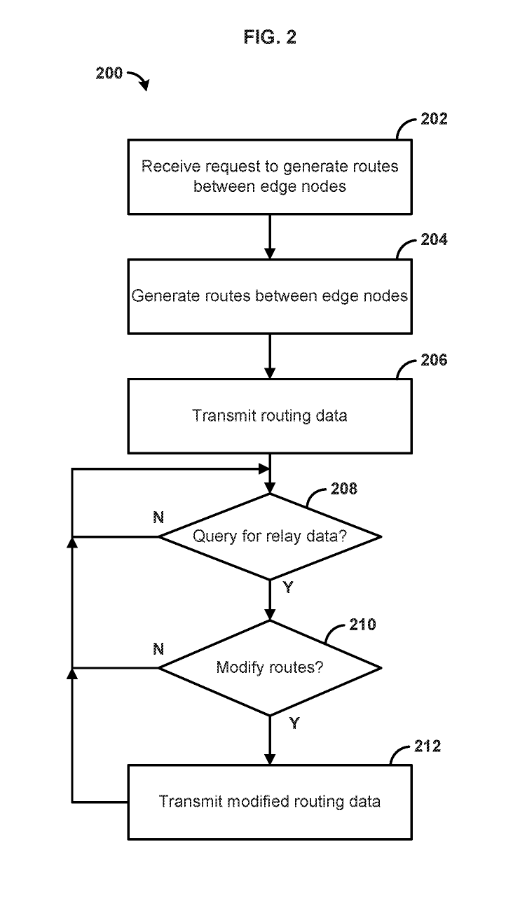

FIG. 2 is a flowchart 200 of an example method. Beginning with step 202, the controller application 122 receives a request from a client 104 to establish a route between a corresponding edge node 114b and an edge node 114a of a server computing environment 101. In response to the request, in step 204, the controller application 122 generates the requested routes. In an aspect, generating a route between the edge node 114b and edge node 114a can comprise querying one or more relay nodes 111a-n for their relay data 123. Using the relay data 123, the controller application 122 can use a path finding or graph search algorithm to generate a plurality of routes between the edge nodes 114a/b according to the relay data 123. In some embodiments, the routes can be generated to minimize a latency between the edge node 114a and 114b. In other embodiments, the controller application 122 can identify, based on the relay data, relay nodes 111a-n having a pending workload meeting or exceeding a threshold, a capacity meeting or falling below another threshold, or another operational metric meeting or exceeding a threshold. The controller application 122 can then generate routes to preferentially exclude the identified relay nodes 111a-n.

In an aspect, after generating the routes, in step 206, the controller application 122 can transmit routing data. In an aspect, the routing data can be transmitted to the edge node 114b, such that overlay packets 127 may be encoded with an indication of a respective route. This allows the overlay packets 127 to be communicated to relay nodes 111a-n with an indication of a communications path through the overlay network 107.

In another aspect, transmitting the routing data can comprise transmitting, to the edge node 114b, routing data indicating one or more first relay nodes 111a-n in the path. In such an embodiment, the controller application 122 can also transmit, to relay nodes 111a-n included in the routes, relay data indicating a respective subsequent relay node 111a-n to which overlay packets 127 should be forwarded. Thus, the edge node 114b and relay nodes 111a-n are only instructed a next node to which overlay packets 127 should be forwarded. In some embodiments, the forwarding instructions to the relay nodes 111a-n may be specific to overlay packets 127 to or from a particular client 104, client application 124, or destination edge node 114a. Thus, relay nodes 111a-n would select a next relay node 111a-n according to the received instructions and a source or destination of the overlay packets 127.

Next, in step 208, the controller application 122 can determine whether to query the relay nodes 111a-n for relay data 123. In an aspect, determining whether to query the relay nodes 111a-n for relay data 123 can include determining whether an interval has passed. In another aspect, determining whether to query the relay nodes 111a-n for relay data 123 can include determining whether a request to query for relay data 123 has been received. For example, an edge node 114a/b, relay node 111a-n, or other component of the networked environment 100b may detect a network status such as a network component outage, a latency meeting or exceeding a threshold, or another event. The detecting component may then communicate a request to the controller application 122 to requery the relay nodes 111a-n for relay data 123.

If a no query for relay data 123 is to be transmitted, the method repeats the execution of step 208. If it is determined that a query is to be transmitted, the control application 122 transmits a query for relay data 123 to one or more relay nodes 111a-n, after which the method advances to step 210. In step 210 the controller application 122 can determine whether to modify one or more of the previously generated routes based on relay data 123 received in response to the query described in step 208. Determining whether to modify one or more previously generated routes can include identifying, based on the relay data 123, one or more of the relay nodes 111a-n has a latency, workload, or other performance attribute meeting or exceeding a predefined threshold. In further embodiments, determining whether to modify one or more previously generated routes can include determining a failure receive relay data 123 from one of the relay nodes 111a-n.

If no route is to be modified, the method returns to step 208. Otherwise, the method advances to step 212 where the control application 122 transmits modified routing data. In an aspect, the control application 122 can transmit the routing data to one or more edge nodes 114a/b or relay nodes 111a-n included in a route indicated in the routing data, or being excluded from a previously generated route as indicated by the routing data. In an aspect, transmitting the modified routing data can include generating one or more routes excluding one or more identified relay nodes 111a-n as described in step 210, or excluding one or more relay nodes 111a-n from which no routing data 123 was received. The generated one or more routes would then be reflected in the transmitted modified routing data. In an aspect, transmitting the modified routing data 212 can include transmitting a notification to one or more excluded relay nodes 111a-n to modify a network address. Thus, the relay nodes 111a-n can be excluded from routes so as not to inhibit network performance, and any DDoS attack that may have affected their performance can be mitigated by the network address change.

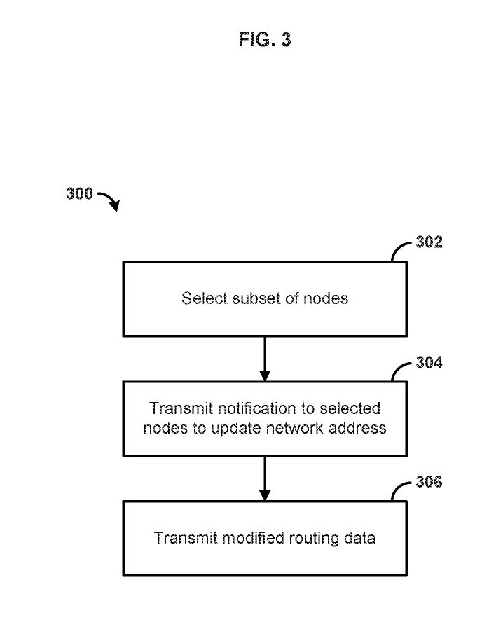

FIG. 3 is a flowchart 300 of an example method. Beginning with step 302, the controller application 122 selects a subsets of relay nodes 111a-n or edge nodes 114a/b to modify their network address. In an aspect, selecting the subset of relay nodes 111a-n or edge nodes 114a/b can be performed at a predefined interval. In another aspect, selecting the subset of relay nodes 111a-n or edge nodes 114a/b can be performed in response to a request from one or more of the relay nodes 111a-n, edge nodes 111a/b, or a request corresponding to a user input to the controller application 122.

In an aspect, the controller application 122 can select the subset of relay nodes 111a-n or edge nodes 114a/b based on a time at which the respective node was last updated. In an aspect, this can include selecting relay nodes 111a-n or edge nodes 114a/b having last updated their respective network addresses outside before a predefined time threshold. In another aspect, this can include selecting N number of nodes having an oldest network address assignment or refresh relative to other nodes, thereby staggering which of the relay nodes 111a-n or edge nodes 114a/b are updating their network addresses. In another aspect, selecting the relay nodes 111a-n can include selecting those relay nodes 111a-n excluded from routes between one or more edge nodes 114a/b, or included in a fewest number of routes. Thus, the number of routes affected by a network address update by a relay node 111a-n are minimized. In another aspect, selecting the relay nodes 111a-n can include selecting those relay nodes 111a-n having a latency, capacity, workload, or other metric meeting or exceeding a threshold. In another aspect, selecting the relay nodes 111a-n can include selecting those relay nodes 111a-n failing to transmit a heartbeat message or relay data 123 to the controller application 122.

Next, in step 304, a notification is transmitted to the selected relay nodes 111a-n or edge nodes 114a/b to update their respective network address. In an aspect, transmitting the notification can include establishing a Transmission Control Protocol (TCP) session with the respective relay nodes 111a-n or edge nodes 114a/b, the notification being transmitted via the TCP session. In another aspect, transmitting the notification can include executing one or more service or Application Program Interface (API) calls associated with the respective relay nodes 111a-n or edge nodes 114a/b. In an aspect, the notification can include a new address for the respective node. Accordingly, transmitting the notification can include querying a Dynamic Host Configuration Protocol (DHCP) server for a new network address. In further embodiments, the controller application 122 may facilitate or simulate DHCP or other network address allocation functionality. In some aspects the new network address may be taken from a pool of network addresses with or without replacement.

In step 306 the controller application 122 control application 122 transmits modified routing data. In an aspect, transmitting the modified routing data can include generating one or more routes. In an aspect, the one or more routes can reflect the updated network addresses. In an aspect, the one or more routes can correspond to a previously generated route with updated network addresses. In an aspect, the one or more routes can include one or more newly generated routes. In an aspect, the routing data can indicate one or more deltas or changes in network addresses, thereby allowing relay nodes 111a-n or edge nodes 114a/b to update their respective routing tables or routing data to reflect the updated network addresses.

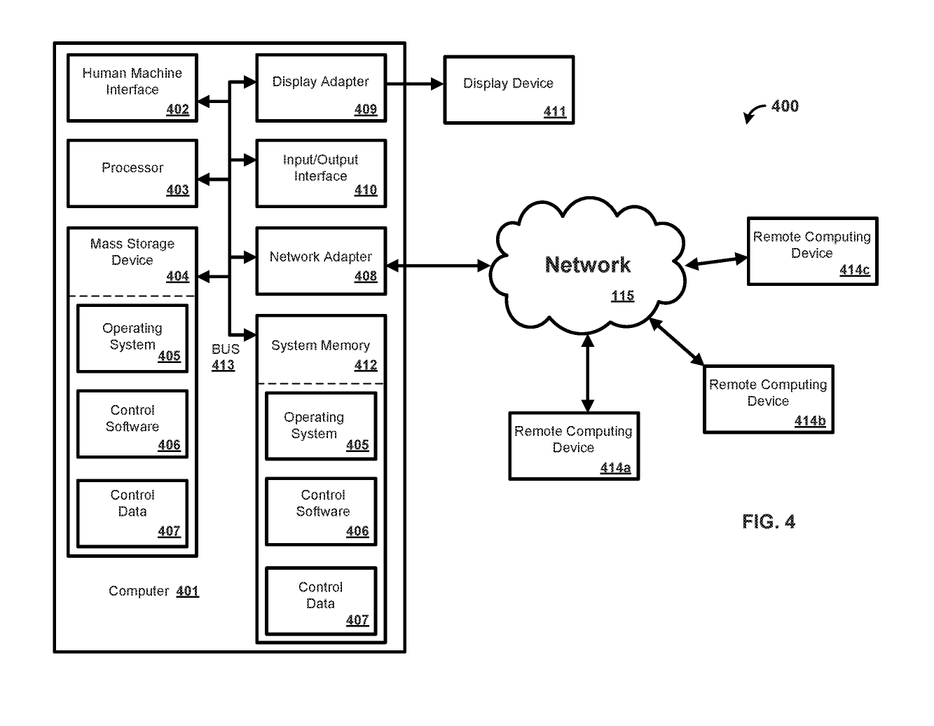

In an exemplary aspect, the methods and systems can be implemented on a computer 401 as illustrated in FIG. 4 and described below. By way of example, the controller computing environment 102 of FIG. 1 can include one or more computers 401 as illustrated in FIG. 4. Similarly, the methods and systems disclosed can utilize one or more computers to perform one or more functions in one or more locations. FIG. 4 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 401. The components of the computer 401 can comprise, but are not limited to, one or more processors 403, a system memory 412, and a system bus 413 that couples various system components including the one or more processors 403 to the system memory 412. The system can utilize parallel computing.

The system bus 413 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the one or more processors 403, a mass storage device 404, an operating system 405, control software 406, control data 407, a network adapter 408, the system memory 412, an Input/Output Interface 410, a display adapter 409, a display device 411, and a human machine interface 402, can be contained within one or more remote computing devices 414a,b,c at physically separate locations, connected through buses of this form, in effect implementing a fully distributed system.

The computer 401 typically comprises a variety of computer readable media. Exemplary readable media can be any available media that is accessible by the computer 401 and comprises, for example and not meant to be limiting, both volatile and non-volatile media, removable and non-removable media. The system memory 412 comprises computer readable media in the form of volatile memory, such as random access memory (RAM), and/or non-volatile memory, such as read only memory (ROM). The system memory 412 typically contains data such as the control data 407 and/or program modules such as the operating system 405 and the control software 406 that are immediately accessible to and/or are presently operated on by the one or more processors 403.

In another aspect, the computer 401 can also comprise other removable/non-removable, volatile/non-volatile computer storage media. By way of example, FIG. 4 illustrates the mass storage device 404 which can provide non-volatile storage of computer code, computer readable instructions, data structures, program modules, and other data for the computer 401. For example and not meant to be limiting, the mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, the operating system 405 and the control software 406. Each of the operating system 405 and the control software 406 (or some combination thereof) can comprise elements of the programming and the control software 406. The control data 407 can also be stored on the mass storage device 104. The control data 407 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 401 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 403 via the human machine interface 402 that is coupled to the system bus 413, but can be connected by other interface and bus structures, such as a parallel port, game port, an IEEE 1394 Port (also known as a Firewire port), a serial port, or a universal serial bus (USB).

In yet another aspect, the display device 411 can also be connected to the system bus 413 via an interface, such as the display adapter 409. It is contemplated that the computer 401 can have more than one display adapter 409 and the computer 401 can have more than one display device 411. For example, the display device 411 can be a monitor, an LCD (Liquid Crystal Display), or a projector. In addition to the display device 411, other output peripheral devices can comprise components such as speakers (not shown) and a printer (not shown) which can be connected to the computer 401 via the Input/Output Interface 410. Any step and/or result of the methods can be output in any form to an output device. Such output can be any form of visual representation, including, but not limited to, textual, graphical, animation, audio, tactile, and the like. The display device 411 and computer 401 can be part of one device, or separate devices.

The computer 401 can operate in a networked environment using logical connections to one or more remote computing devices 414a,b,c. By way of example, a remote computing device can be a personal computer, portable computer, smartphone, a server, a router, a network computer, a peer device or other common network node, and so on. Logical connections between the computer 401 and a remote computing device 414a,b,c can be made via a network 415, such as a local area network (LAN) and/or a general wide area network (WAN). Such network connections can be through the network adapter 408. The network adapter 408 can be implemented in both wired and wireless environments. Such networking environments are conventional and commonplace in dwellings, offices, enterprise-wide computer networks, intranets, and the Internet.

For purposes of illustration, application programs and other executable program components such as the operating system 405 are illustrated herein as discrete blocks, although it is recognized that such programs and components reside at various times in different storage components of the computing device 401, and are executed by the one or more processors 403 of the computer. An implementation of the control software 406 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method, comprising:
querying a plurality of relay nodes for relay data, the plurality of relay nodes being included in a plurality of routes from a first edge node to a second edge node, the relay data indicating an operational status of a respective one of the relay nodes;
identifying, based on the relay data, at least one of the relay nodes as at least one of: having an operational metric meeting or exceeding a predefined threshold, or failing to respond to the querying;
modifying at least one network address of the identified at least one of the relay nodes;
updating the plurality of routes based on the modified at least one network address.

2. The method of claim 1, wherein querying the plurality of relay nodes for relay data is performed at a predefined interval.

3. The method of claim 1, wherein the operational metric comprises at least one of a capacity, a workload, a number of pending operations, or a latency.

4. The method of claim 1, wherein modifying the at least one network address of the identified at least one of the relay nodes comprises transmitting a notification to the identified at least one of the relay nodes.

5. The method of claim 4, wherein the notification comprises a modified network address.

6. The method of claim 1, further comprising generating the plurality of routes based on other relay data from the plurality of relay nodes.

7. The method of claim 1, wherein updating the plurality of routes comprises transmitting updated routing data to at least one of: the first edge node, the second edge node, or at least a subset of the plurality of relay nodes.

8. The method of claim 7, wherein the subset of the plurality of relay nodes are included in a subset of the plurality of routes including the identified at least one of the relay nodes.

9. The method of claim 1, wherein the plurality of routes are updated to exclude the identified at least one of the relay nodes.

10. A method, comprising:
identifying at least one of a plurality of relay nodes, the plurality of relay nodes being included in a plurality of routes from a first edge node to a second edge node, the relay data indicating an operational status of a respective one of the relay nodes;
modifying at least one network address of the identified at least one of the relay nodes;
updating the plurality of routes based on the modified at least one network address.

11. The method of claim 10, wherein identifying the at least one of the plurality of relay nodes is performed at a predefined interval.

12. The method of claim 10, wherein identifying the at least one of the plurality of relay nodes is based on a last modified time of the at least one network address.

13. The method of claim 10, wherein identifying the at least one of the plurality of relay nodes is based on a degree of inclusion in the plurality of routes.

14. The method of claim 10, wherein modifying the at least one network address comprises incrementing or decrementing the at least one network address.

15. The method of claim 10, wherein modifying the at least one network address comprises:
establishing a network connection to the identified at least one of the relay nodes; and
transmitting at least one modified network address to the identified at least one of the relay nodes via the network connection.

16. The method of claim 10, wherein the network connection comprises a transmission control protocol (TCP) connection.

17. The method of claim 10, wherein identifying the at least one of the relay nodes comprises determining that at least one heartbeat message from the at least one of the relay nodes was not received.

18. The method of claim 10, wherein identifying the at least one of the relay nodes comprises determining that at least one operational metric corresponding to the at least one of the relay nodes meets or exceeds a threshold.

19. The method of claim 10, wherein the plurality of routes are updated to exclude the identified at least one of the relay nodes.

20. The method of claim 10, further comprising modifying another network address of at least one of the first edge node or the second edge node.
